(19) United States
(12) Patent Application Publication
(10) Pub. No.: US 2004/0208646 A1
(43) Pub. Date: Oct. 21, 2004

(54) System and method for multi-level phase modulated communication

(76) Inventors: Seemant Choudhary, Dallas, TX (US); Takeshi Hoshida, Richardson, TX (US); Michael C. Parker, Colchester (GB)

Correspondence Address: BAKER BOTTS L.L.P., 2001 ROSS AVENUE, SUITE 600, DALLAS, TX, 75201-2980, US

(21) Appl. No.: 10/052,886

(22) Filed: Jan. 18, 2002

(51) Int. Cl. H04J 14/02; H04B 10/04

(52) U.S. Cl. 398/188

(57) ABSTRACT

A method for transmitting a signal includes providing a source signal and splitting the source signal into a first and second split signal. The first split signal is modulated based on a first dataset. The second split signal is phase shifted and modulated based on a second dataset. The modulated second signal is orthogonally polarized with respect to the polarization of the modulated first signal and combined with the modulated first signal. The combined signal may also be modulated and transmitted.

### TECHNICAL FIELD OF THE INVENTION

The present invention relates generally to communication networks and, more particularly, to a system and method for multi-level phase modulated communication.

### BACKGROUND OF THE INVENTION

Telecommunications systems, cable television systems, and data communication networks use optical networks to rapidly convey large amounts of information between remote points. In an optical network, information is conveyed in the form of optical signals through optical fibers. Optical fibers comprise thin strands of glass capable of transmitting the signals over long distances with very little loss. The optical signals have at least one characteristic modulated to encode audio, video, textual, real-time, non-real-time and/or other suitable data. Modulation may be based on phase shift keying (PSK), intensity shift keying (ISK), or other suitable methodologies.

In Quadrature Phase Shift Keying (QPSK) modulation, the phase of a carrier signal is modulated and takes on one of four possible values corresponding to a symbol set. In QPSK, the carrier signal may be split into two arms, the first of which, called the in-phase component, is phase modulated directly. The second arm, called the quadrature component, may be phase modulated after an additional ninety degree phase shift. The two arms are combined to produce one QPSK signal.

QPSK receivers use a Phase Locked Loop (PLL) with a local oscillator. Insufficient PLL response time leads to crosstalk between the in-phase and quadrature components of the QPSK signal, resulting in signal quality degradation.

### SUMMARY OF THE INVENTION

In accordance with the present invention, a system and method for multi-level phase modulated communication are provided which substantially eliminate or reduce disadvantages and problems associated with previous systems and methods.

A method for transmitting a signal includes providing a source signal and splitting the source signal into a first and second split signal. The first split signal is modulated based on a first dataset. The second split signal is phase shifted and modulated based on a second dataset. The polarization of the modulated second signal is rotated or otherwise controlled to be orthogonal with respect to the polarization of the modulated second signal and combined with the modulated first signal. The combined signal may also be modulated and transmitted.

In another embodiment, a method for receiving a signal includes receiving a signal and providing a local signal. The local signal is circularly polarized and combined with the received signal. The combined signal is split into a first and second split signal and the first and second split signals are detected. Feedback is generated to modify the local signal.

Embodiments of the invention provide various technical advantages. Technical advantages include providing a method for transmitting a signal, which includes polarization multiplexing of I and Q components in QPSK. The polarization multiplexing reduces crosstalk in the presence of phase errors. Another technical advantage includes taking advantage of polarization multiplexing of I and Q components at the receiver, thereby reducing crosstalk and simplifying the receiver design. An additional technical advantage includes providing a transmitter and receiver configuration for polarization multiplexed and intensity modulated QPSK. Still another technical advantage includes providing intensity modulation to a modified QPSK signal in order to suppress degradation caused by SPM/XPM+GVD in transmission over optical fiber.

Still another technical advantage includes the use of intensity modulation at the transmitter to improve non-linear tolerance of QPSK. Moreover, other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 is a block diagram illustrating an optical communication system in accordance with one embodiment of the present invention;

FIGS. 2A-B are block diagrams illustrating the optical transmitter of FIG. 1 in accordance with several embodiments of the present invention;

FIG. 3 is a block diagram illustrating the optical transmitter of FIG. 2A, implemented in a planar lightwave circuit, in accordance with one embodiment of the present invention;

FIG. 4 is a block diagram illustrating the optical transmitter of FIG. 2A, implemented with discrete elements, in accordance with one embodiment of the present invention;

FIG. 5 is a block diagram illustrating the optical transmitter of FIG. 2A, implemented with free space optics, in accordance with one embodiment of the present invention;

FIG. 6 is a block diagram illustrating the optical receiver of FIG. 1 in accordance with one embodiment of the present invention;

FIG. 7 is a block diagram illustrating the optical receiver of FIG. 6, implemented in a planar lightwave circuit, in accordance with one embodiment of the present invention;

FIG. 8 is a block diagram illustrating the optical receiver of FIG. 6, in accordance with one embodiment of the present invention;

FIG. 9 is a flow diagram illustrating a method for transmitting a signal in accordance with one embodiment of the present invention; and

FIG. 10 is a flow diagram illustrating a method for receiving a signal in accordance with one embodiment of the present invention.

### DETAILED DESCRIPTION OF THE INVENTION

FIG. 1 illustrates an optical communications system in accordance with one embodiment of the present invention. Optical communications system 1 includes a transmission module 2 coupled to a receiver module 3 via an optical link 4. Transmission module 2 generates optical signals based on data for transmission over optical link 4 to receiver module 3. Receiver module 3 receives the optical signals and extracts the data.

Transmission module 2 includes a multiplexer 5 and a plurality of optical transmitters 10. Optical transmitters 10 modulate a signal based on data to produce a modulated signal. In one embodiment, each optical transmitter 10 produces a modulated signal on a distinct wavelength. As used throughout, each means all of a particular subset. Multiplexer 5 receives the modulated signals generated by the optical transmitters 10 and combines them for transmission over optical link 4. In one embodiment, the signals are combined according to a Dense Wavelength Division Multiplexing (DWDM) technique. Once combined, the resultant optical signal is transmitted over optical link 4 to receiver module 3.

Optical link 4 includes one or more spans of optical fiber. The optical fiber may be constructed of glass, a liquid core in a plastic casing, or otherwise suitably constructed to transmit optical signals. One or more optical amplifiers may also be distributed along the one or more spans of optical fiber.

Receiver module 3 includes a demultiplexer 6 and a plurality of optical receivers 8. Demultiplexer 6 receives the combined optical signal over optical link 4 and extracts the original modulated signals used to create the combined optical signal. In one embodiment, the combined optical signal is a DWDM signal and is demultiplexed accordingly. Demultiplexer 6 transmits the extracted modulated signals to the optical receivers 8 on a one-to-one basis. The extracted modulated signals may also be distributed in a variety of ways, including, for example, distribution based on traffic volume or on an as available basis. Optical receivers 8 receive the extracted modulated signals and extract the data used by optical transmitters 10 to produce the modulated signals.

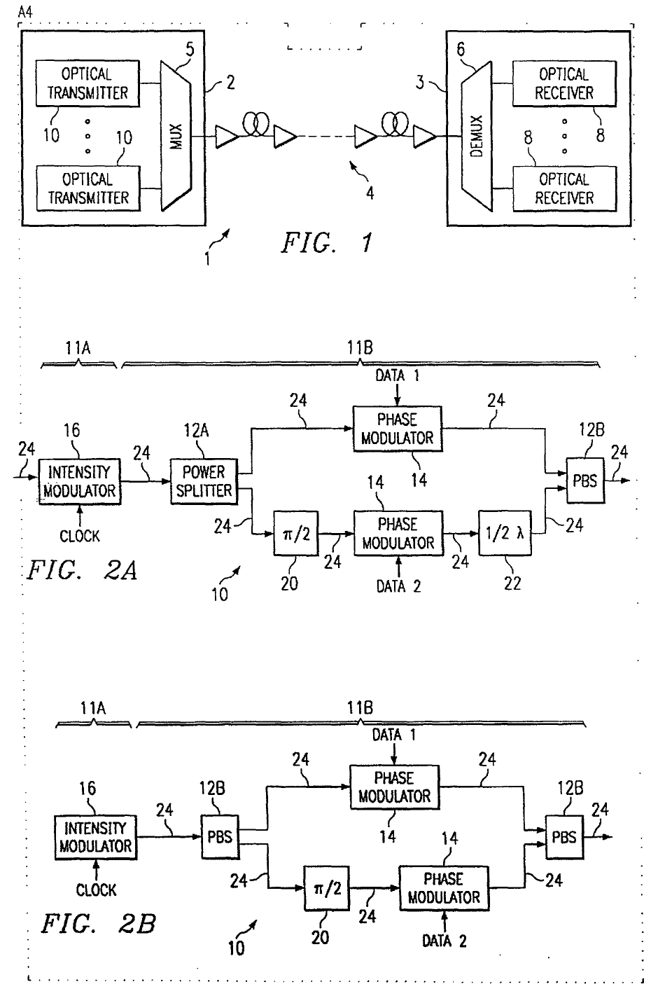

FIG. 2A illustrates details of the optical transmitter 10 in accordance with one embodiment of the present invention. In this embodiment, optical transmitter 10 is a multi-stage modulator. The first stage 11A modulates a signal for transmission using intensity modulation. The second stage 11B modulates the first stage signal using a combination of Quadrature Phase Shift Keying (QPSK) with polarization multiplexing. Optical transmitter 10 may include other or different suitable stages. For example, optical transmitter 10 may instead modulate a signal using QPSK and then modulate the intensity of the QPSK signal. While the present invention is described in an optical communications system, it will be understood that other suitable systems may also be employed, such as microwave communication systems, for example.

Referring to FIG. 2A, a first stage 11A includes intensity modulator 16. Intensity modulator 16 is operable to modulate the intensity of an optical signal based on data. In the illustrated embodiment, intensity modulator 16 modulates the intensity of an optical signal based on a clock signal. The clock signal may be a symbol synchronous sinusoidal clock signal, synchronized with a data signal. It will be understood that other suitable signals or data may be used to provide the data by which intensity modulator 16 modulates the intensity of an optical signal.

The second stage 11B includes a power splitter 12A, a polarization beam splitter 12B, a plurality of phase modulators 14, a phase shifter 20, a half-wave plate 22, and a plurality of optical links 24. Power splitter 12A is any device operable to receive a plurality of signals and combine or otherwise passively generate a combined signal based on the received signals and/or to receive a signal and to split the received signal into discrete signals or otherwise passively generate discrete signals based on the received signal. The discrete signals may be identical in form and/or process or may suitably differ. Polarization beam splitter 12B is any device operable to receive a plurality of signals and combine or otherwise passively generate a combined signal based on the received signals and their associated polarization and/or to receive a signal and to split the received signal into discrete signals or otherwise passively generate discrete signals of disparate polarization states based on the received signal. Phase modulator 14 is operable to modulate the phase of an optical signal based on data.

Phase shifter 20 is operable to shift a phase of an optical signal. Half wave plate 22 is operable to rotate the polarization of an optical signal by ninety degrees. Optical links 24 link the various components of optical transmitter 10 as shown in FIG. 2A. In particular, an optical link 24 connects an intensity modulator 16 with a power splitter 12A. Optical links 24 connect power splitter 12A with a first phase modulator 14 and the phase shifter 20. Optical links 24 connect the first phase modulator 14 with a polarization beam splitter 12B. Optical links 24 connect the first phase shifter 20 with a second phase modulator 14 and the second phase modulator 14 with the half wave plate 22. Optical link 24 also connects the half wavelength plate 22 with the polarization beam splitter 12B. Each optical link 24 may be an optical fiber and may be formed with varying types of materials that affect the transport characteristics of light flows along optical link 24.

In operation, optical transmitter 10 receives a carrier signal, modulates the carrier signal intensity, splits the intensity modulated signal into two arms and modulates the phase of each arm to produce a combined quadrature phase shift keying (QPSK) signal resulting in intensity modulated quadrature phase shift keying (IM/QPSK). In QPSK modulation, the phase of the carrier signal is modulated and takes on values from the set [−45°, 45°, 135°, −135°] corresponding to the symbol set [10, 11, 01, 00], respectively.

The carrier signal may be provided by a continuous wave laser and may be mathematically expressed, for example, as A cos(2πf_{c}t), where A is amplitude, f_{c} is the carrier frequency, and t is time.

The carrier signal is first intensity modulated by intensity modulator 16. In the illustrated embodiment, the carrier signal is modulated based on a twenty GHz symbol synchronous clock signal, synchronized with a data signal. Intensity modulator 16 transmits the intensity modulated signal to the power splitter 12A.

The intensity modulated signal enters the power splitter 12A where it is split into two signals, the first of which travels along an optical link 24 to the first phase modulator 14. Phase modulator 14 directly phase-modulates the signal based on a first data source at twenty Gb/s, the resulting signal called the in-phase component (I component). The in-phase component travels along optical link 24 to the polarization beam splitter 12B, in this case functioning as a combiner.

The second signal coming from power splitter 12A travels along optical link 24 to phase shifter 20. Phase shifter 20 shifts the phase of the carrier source signal by 90 degrees. In some embodiments, phase shifter 20 may be “invisible”—for example, a direct current (DC) voltage may be applied to the second phase modulator 14 to effect the phase shift. Alternatively, the phase may be shifted by manipulating the optical path length or by taking advantage of the electro-optic effect and/or non-linearity, or other suitable methods.

After the carrier signal is phase shifted, the phase-shifted signal travels along optical link 24 to the second phase modulator 14, where the phase-shifted signal is directly phase-modulated by a second data source at 20 Gb/s, resulting in a signal called the quadrature component (Q component). The quadrature component travels along optical link 24 to half wave plate 22, where the signal polarization is rotated by ninety degrees, such that it is orthogonal to the polarization of the in-phase component generated by first phase modulator 14.

In a particular embodiment, where the carrier signal is launched in transverse electric (TE) polarization, half wave plate 22 converts it to transverse magnetic (TM) polarization. TE and TM polarization may be described by the following mathematical formulae:

TE=Eₓ cos(\hat{ω}_{c}t)î+E_{y} cos(\hat{ω}_{c}t+θ)ĵ, where E_{y}=0

TM=Eₓ cos(\hat{ω}_{c}t)î+E_{y} cos(\hat{ω}_{c}t+θ)ĵ, where Eₓ=0

where Eₓ is the amplitude of polarization in the x-direction, E_{y} is the amplitude of the polarization in the y-direction, \hat{ω}_{c} is the carrier frequency; t is time; î is the unit vector in the direction of the x-axis; ĵ is the unit vector in the direction of the y-axis; and θ is the arbitrary phase difference. The resultant signals, that is, the I and Q components, are therefore orthogonal to each other, with the I component at transverse electric (TE) polarization and the Q component at transverse magnetic (TM) polarization.

The in-phase and quadrature components are combined at polarization beam splitter 12B. The combined signal may be described mathematically, for example, as Eₓ cos (\hat{ω}_{c}t+θ₁(t))î+E_{y} sin (\hat{ω}_{c}t+θ₂(t)) ĵ, where θ₁(t) is a first data stream in phase modulated format and θ₂(t) is a second data stream in phase modulated format.

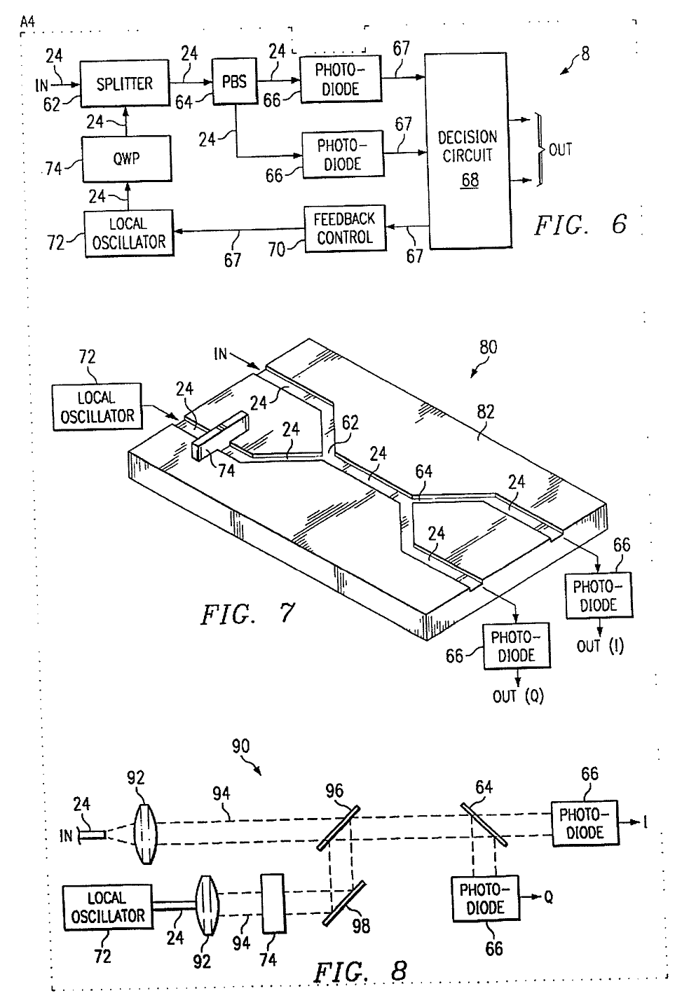

In the illustrated embodiment, the resultant intensity modulated QPSK signal is then sent for transmission along optical link 24. In an exemplary embodiment, the resultant transmission rate is 40 Gb/s symbol synchronous intensity modulated QPSK. As described above, the first stage is intensity modulation with a 20 GHz symbol As described above, the first stage is intensity modulation with a 20 GHz symbol synchronous sinusoidal clock signal. The second stage is QPSK modulation with polarization multiplexing. Thus, the intensity is reduced when there is a phase discontinuity in the signal. The advantage of intensity modulation is to suppress the degradation caused by SPM/XPM+GVD in transmission over fiber. As will be shown below, in connection with FIGS. 6, 7, and 8, the advantage of polarization multiplexing is to reduce the crosstalk between the in-phase and quadrature components.

FIG. 2B illustrates an optical transmitter 10 in accordance with another embodiment of the present invention. Like the optical transmitter of FIG. 2A, optical transmitter 10 includes a first stage 11A and second stage 11B. First stage 11A modulates an optical signal for transmission using intensity modulation. Second stage 11B modulates the first stage signal using a combination of QPSK with polarization multiplexing.

First stage 11A includes an intensity modulator 16 operable to modulate the intensity of an optical signal based on a clock signal. Second stage 11B includes a first and second polarization beam splitter 12B, a first and second phase modulator 14, phase shifter 20, and a plurality of optical links 24.

In operation, optical transmitter 10 functions in a manner substantially similar to the optical transmitter of FIG. 2A. However, the use of a first polarization beam splitter 12B renders a half wave plate unnecessary. This configuration requires the polarization of the optical signal entering first polarization beam splitter 12B to be linearly polarized at an angle of forty-five degrees relative to an axis of the first polarization beam splitter 12B.

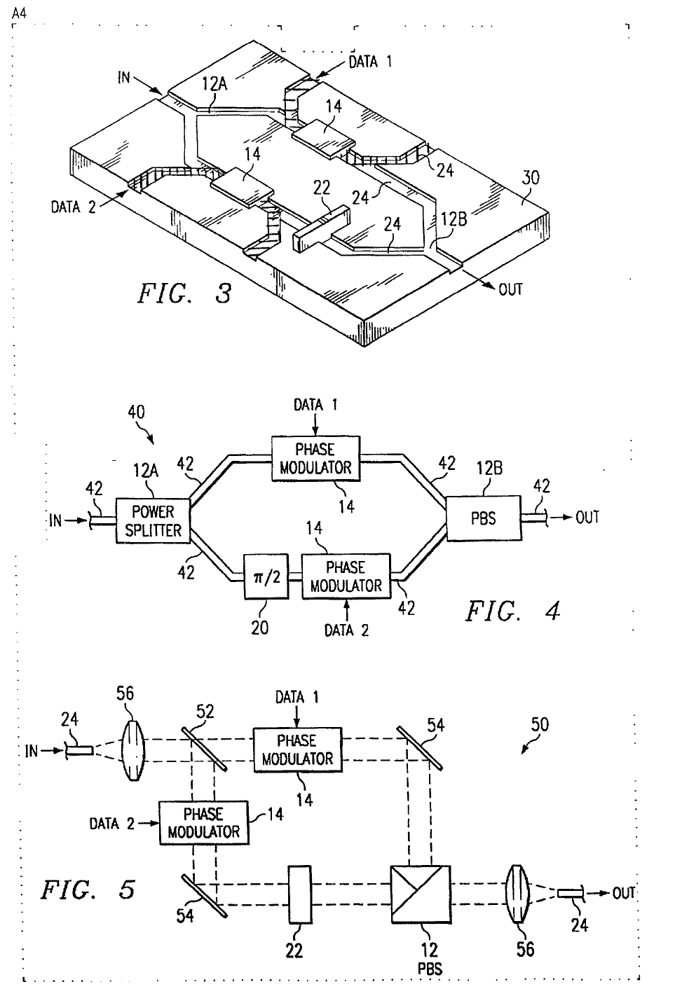

FIG. 3 illustrates an implementation of the system of FIG. 2A, in particular, a planar light wave circuit. Planar light wave circuit 30 includes a power splitter 12A, a polarization beam splitter 12B, a plurality of phase modulators 14, a half wavelength plate 22, and a plurality of optical links 24 interconnecting the components.

In operation, the carrier signal enters an ingress section of planar light wave circuit 30, where the signal is split into two branches by the power splitter 12A. The first branch proceeds to a first phase modulator 14 wherein the carrier signal is directly phase modulated according to a first dataset received along the electrical wave guide (hatched) to generate a first modulated signal (the I component). The second branch of the split signal travels to the second phase modulator 14, which shifts the phase of the carrier signal and modulates the phase shifted signal based on a second dataset received along the electrical wave guide (hatched) to generate a second modulated signal (the Q component). After modulation based on the second dataset, the modulated signal travels along optical link 24 to half wavelength plate 22, where the polarization of the Q component is rotated to be orthogonal to the polarization of the I component. The in-phase and quadrature components travel along optical links 24 to the polarization beam splitter 12B, where the signals are combined and travel out of planar light wave circuit 30 through an egress section. From planar light wave circuit 30, the resultant QPSK signal may then be intensity modulated in a similar fashion to that shown in accordance with FIG. 2A (not shown here). Alternatively, the carrier signal may be intensity modulated before it enters planar light wave circuit 30. Planar light wave circuit 30 may be constructed of various materials conducive to transmission of optical signals or light through the material, such as, for example, lithium niobate or silica.

FIG. 4 illustrates an embodiment of the system of FIG. 2A as discrete elements connected by optical fiber. Optical transmitter 40 includes polarization maintaining fiber (PMF) 42 connecting a splitter 12A with a pair of phase modulators 14 and a phase shifter 20. PMF 42 further connects the phase modulators 14 to polarization beam splitter 12B. In operation, a carrier signal enters the splitter 12A, where it is split into two arms, each of which travel along PMF 42 to the first and second phase modulators. In the second arm, the signal passes through the phase shifter 20 before the phase modulator. The first phase modulator 14 modulates a phase of the signal based on a first dataset, to generate a first modulated signal (the I component). Phase shifter 20 shifts the phase of the optical signal on the second arm. Second phase modulator 14 modulates the phase of the second arm of the carrier signal based on a second dataset, to generate a second modulated signal (the Q component). The polarization of the Q component is rotated to be orthogonal to the polarization of the I component. The quadrature (Q) component proceeds along PMF 42 to the polarization beam splitter 12B. The in-phase and quadrature components are combined at polarization beam splitter 12B where the combined signal may be then passed to an intensity modulator for intensity modulation and further transmission.

FIG. 5 illustrates the system of FIG. 2A, in a free space optics environment in accordance with yet another embodiment of the present invention. Optical transmitter 50 includes optical links 24, two phase modulators 14, polarization beam splitter 12, half wave plate 22, half mirror 52, mirrors 54, and lenses 56. In operation, the carrier signal passes through optical link 24 and shines onto lens 56, which concentrates the light onto half mirror 52. Half mirror 52 is operable to split the light into two discrete beams, each of which passes to one of the phase modulators 14. The first phase modulator 14 modulates the phase of the light beam based on a first dataset and the second phase modulator 14 shifts the phase of the signal and modulates the phase-shifted beam of light based on a second dataset. Both beams leave their respect phase modulators 14 and travel to a mirror 54. The light beam of phase modulated light from the first phase modulator 14 reflects from the first mirror 54 directly to the polarization beam splitter 12 (the in-phase (I) component). The second phase modulated light reflects from the second mirror 54 and passes through half wave plate 22, where the light is polarized to be orthogonal to the I component. The resultant light beam (the Q component) passes from half wave plate 22 to polarization beam splitter 12, where it is combined with the I component. The combined light beam shines on a second lens 56, where it is concentrated on an input side of optical link 24 for further transmission. A power combiner may be used in place of the polarization beam splitter 12. In addition, in another embodiment, a polarization beam splitter 12 may be used in place of half mirror 52 and the half wave plate 22 omitted. In this embodiment, the signal is linearly polarized at 45 degrees relative to the axis of the polarization beam splitter.

FIG. 6 illustrates details of an the optical receiver 8 of FIG. 1, in accordance with one embodiment of the present invention. In this embodiment, optical receiver 8 receives and processes different types of signals. Optical receiver 8 includes a plurality of optical links 24, a first splitter 62, a polarization beam splitter 64, a plurality of photodiodes 66, and electrical links 67. Optical receiver 8 also includes a decision circuit 68, a feedback control 70, a local oscillator 72, and a quarter wave plate 74. First splitter 62 is operable to receive an optical signal at an ingress section from optical link 24 and to combine that signal with a local oscillator signal received from the optical link 24 connecting first splitter 62 to quarter wave plate 74. First splitter 62 is operable to combine these two signals and transmit them along optical link 24 to polarization beam splitter 64. It will be understood that the first splitter 62 may be any optical coupler operable to combine the received signal from the in branch of optical link 24 and the signal received from quarter wave plate 74. Thus, splitter 62 may be a half mirror, a 50-50 path splitter/combiner, a fusion fiber coupler, a three decibel coupler, or any other device operable to combine the two signals and produce a single output in the most efficient way.

Polarization beam splitter 64 is operable to split the signal received from first splitter 62 into discreet signals or otherwise passively generate discreet signals based on the received signal. Polarization beam splitter 64 is operable to split the signal received from first splitter 62 into its transverse electric (TE) and transverse magnetic (TM) components. Thus, in this embodiment, any phase error in the local oscillator 72 will only result in signal attenuation, not cross-talk. Thus, the polarization beam splitter 64 is operable to split the received signal into its I and Q components by differentiating between the different polarizations associated with each component. That is, transverse electric (TE) for the in-phase component and transverse magnetic (TM) for the quadrature component. Each component is received by a photodiode 66 which, as mentioned below, converts the signals into an electrical signal which is then processed by decision circuit 68. The split signals from polarization beam splitter 64 travel along optical links 24 to photodiodes 66.

Photodiodes 66 are operable to convert the optical signals received from the polarization beam splitter 64 into electrical signals, which are then transmitted along electrical links 67 to decision circuit 68. Decision circuit 68 then retrieves the various components of the optical signals and converts them into the intended data streams.

Decision circuit 68 is connected to a feedback control 70 along an electrical link 67. Feedback control 70 is operable to modify the output of local oscillator 72 through a control link via electrical link 67, based on information received from decision circuit 68. Feedback control 70 operates in a fashion similar to a phase lock loop (PLL), and is used to minimize phase noise. Local oscillator 72 is operable to provide an optical output, in a similar fashion to the carrier source of FIG. 2. The local oscillator signal travels along optical link 24 to quarter wave plate 74. Quarter wave plate 74 is operable to transform a linearly polarized signal received from local oscillator 72 into circular polarization and to transmit that circularly polarized signal along optical link 24 for combination with the input signal at first splitter 62.

In this embodiment it is assumed that the received light at first splitter 62 has already been aligned with the I component of the signal, that is, the received signal is in transverse electric (TE) polarization. This may be performed by, for example, an automatic polarization controller (APC) device, or other suitable devices. The signal received by first splitter 62 may also be filtered with a polarization mode dispersion compensator (PMDC) device along with the automatic polarization controller (APC). It will also be understood by those skilled in the art that where the local oscillator 72 emits circularly polarized light, there is no need for the quarter wave plate 74.

FIG. 7 illustrates the optical receiver of FIG. 6, as implemented in a planar light wave circuit, in accordance with one embodiment of the present invention. Optical receiver 80 includes planar light wave medium 82, a plurality of optical links 24, a first splitter 62, a polarization beam splitter 64, two or more photodiodes 66, a quarter wave plate 74, and a local oscillator 72. Planar light wave medium 82 may comprise any suitable medium operable to propagate light. Planar light wave medium 82 may comprise, for example, lithium niobate, silica and the like.

In operation, an optical signal is received at the in side of optical receiver 80 and travels along optical link 24 where it is combined with a signal received from local oscillator 72 at first splitter 62. Local oscillator 72, as described above, in conjunction with FIG. 6, produces a signal that travels along an optical link 24 to a quarter wave plate 74, where the signal is circularly polarized. The circularly polarized signal is combined with the received signal at first splitter 62. The combined signal passes along an optical link 24 to the polarization beam splitter 64 where the signal is split into the I and Q components. The I and Q optical signals are then transmitted to a photodiode 66 where they are converted into electrical signals for processing.

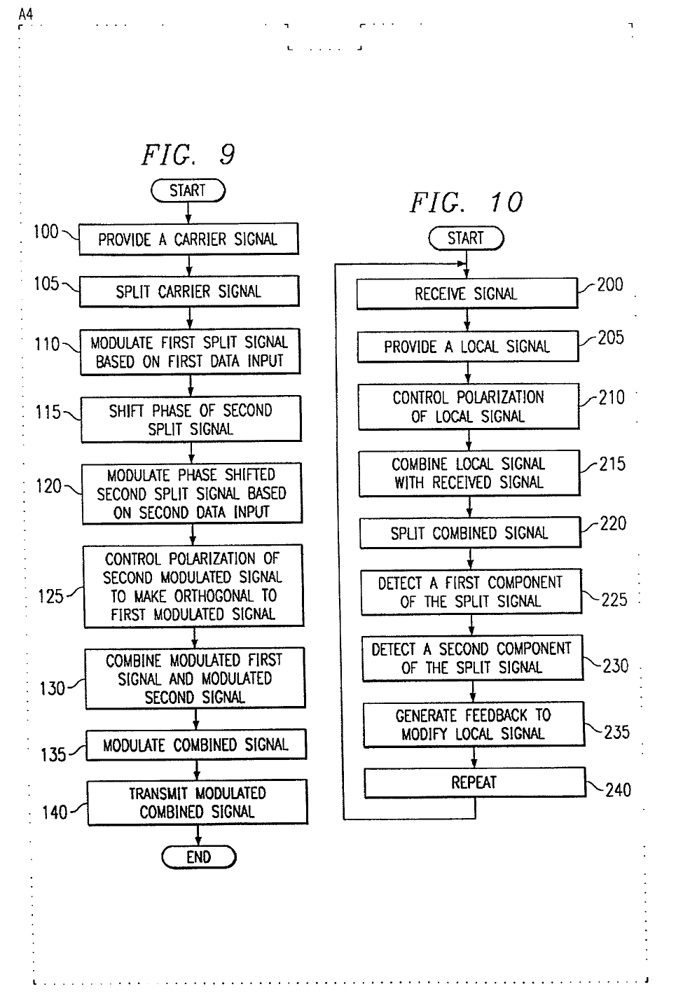

FIG. 8 illustrates the optical receiver of FIG. 6, as implemented in a free space optics environment, in accordance with one embodiment of the present invention. Optical receiver 90 includes an optical link 24, lenses 92, a plurality of light beams 94, a half mirror 96, a polarization beam splitter 64, a mirror 98, two or more photodiodes 66, a local oscillator 72, and a quarter wave plate 74. In operation, an optical signal is received at the in node at optical link 24, where the optical signal is received on a lens 92, which converts the optical signal into a light beam 94. Light beam 94 travels to half mirror 96 where it is combined with a signal received and reflected off of mirror 98. Local oscillator 72 generates a carrier signal along another optical link 24, which travels to a second lens 92 converting the signal into a light beam 94. The light beam then passes through a quarter wave plate 74, which, as described above, ensures that the light is circularly polarized. The circularly polarized light reflects off of mirror 98 to half mirror 96, where it is combined with the light beam generated by lens 92. The combined light passes to a polarization beam splitter 64 where the light is split into I and Q components and shines onto two or more photodiodes 66. As described above, photodiodes 66 are operable to convert the received light of the I and Q components of the signal from an optical to an electrical signal for further processing. Mirror 98 can be eliminated by locating local oscillator 72, lens 92, light beam 94, and quarter wave plate 74 in a vertical configuration. Further details of the present invention will become apparent in connection with the methods described in FIGS. 9 and 10.

FIG. 9 is a flow diagram illustrating a method for transmitting a signal in accordance with one embodiment of the present invention. In this embodiment, intensity modulation independent of polarization state of the signal is performed at the second stage, with phase modulation being performed at the first stage.

The process begins at step 100 wherein a carrier signal is provided. As described above, this step may be performed by a local oscillator or continuous wave laser, or other means suitable to produce a carrier signal. Next, at step 105, the carrier signal is split into two discreet arms. As described above, this step may be, for example, performed by the beam splitter 12A of FIG. 2A, or, for circularly polarized light by a polarization beam splitter.

At step 110, the first split signal is modulated based on a first data input. This step may be performed by the first phase modulator 14 of FIG. 2A. Next, at step 115, the phase of the second split signal split in step 105 above is shifted by π/2 radians. As described above, this may be performed by the phase shifter 20 of FIG. 2A. Next, at step 120, the phase shifted second split signal is modulated based on a second data input. This step may be performed by the second phase modulator 14 of FIG. 2A.

Next, at step 125, the polarization of the second modulated signal is made orthogonal to polarization of the first modulated signal. This step may be performed by the half wave plate 22 of FIG. 2A, or otherwise suitably polarized. Next, at step 130, the modulated first signal and the orthogonally polarized second signal are combined. This step may be performed by the polarization beam splitter 12B of FIG. 2A or a splitter. At step 135, the combined signal is modulated. This step may be performed by intensity modulator 16 in an embodiment in which it is the second stage and may be modulated based on a clock signal. Next, at step 140, the modulated combined signal is transmitted and the process ends.

FIG. 10 is a flow diagram illustrating a method for receiving and processing a signal in accordance with another embodiment of the present invention. The process begins at step 200 wherein an intensity modulated QPSK signal is received. At step 205 a local signal is provided. This step may be performed by, for example, local oscillator 72 of FIG. 6. At step 210 the local signal is transformed to a circular polarization. As described above, this step may be performed by the quarter wave plate 74 of FIG. 6.

At step 215, the polarized local signal is combined with the received signal. This step may be performed by the first splitter 62 of FIG. 6. At step 220, the combined signal is then split into two discreet signals. This step may be performed by the polarization beam splitter 64 of FIG. 6.

At step 225, a first component of the split signal is detected. This may be either the I or Q components of the received signal, and may be performed by photodiode 66 of FIGS. 6, 7, and 8. At step 230, a second component of the split signal is detected, the other of the two signals. That is, if the I component is detected at step 225, then the Q component is detected at step 230. As with step 225, this step may be performed by photodiode 66 of FIGS. 6, 7, and 8.

At step 235, feedback is generated to modify the local signal in order to provide a phase locked look (PLL) for the receiver. This step may be performed by decision circuit 68 and feedback control 70 of FIG. 6. At step 240, the process repeats, wherein a signal is received (Step 200).

Although the methods of FIGS. 9 and 10 have been shown with specific steps in a specific order, it will be understood that the steps may be performed in a different order as appropriate, and other steps may be added or omitted as appropriate in keeping with the spirit of the present invention.

Although the present invention has been described with several embodiments, various changes and modifications may be suggested to one skilled in the art. It is intended that the present invention encompass its changes and modifications as fall within the scope of the appended claims.

What is claimed

1. A method for modulating a signal for transmission, comprising:
receiving a source signal;
splitting the source signal into a first split signal and second split signal;
modulating the first split signal based on a first dataset to generate a first modulated signal;
shifting a phase of the second split signal to generate a phase-shifted second split signal;
modulating the phase-shifted second split signal based on a second dataset to generate a modulated second signal;
controlling the polarization of the modulated second signal; and
combining the modulated first signal and the modulated second signal to generate a combined signal.

2. The method of claim 1, wherein the polarization of the second signal is controlled to be orthogonal to the polarization of the modulated first signal.

3. The method of claim 1, wherein the phase-shift is ninety degrees.

4. The method of claim 1, wherein immediately prior to combination, the polarization of the modulated first signal is transverse electric (TE) polarization, and the polarization of the polarized second signal is transverse magnetic (TM) polarization.

5. The method of claim 1, wherein the modulation is by phase modulation.

6. The method of claim 1, further comprising modulating the source signal.

7. The method of claim 6, wherein the source signal is modulated by intensity modulation.

8. The method of claim 7, wherein the intensity modulation is periodic.

9. The method of claim 7, wherein the intensity modulation is by a clock signal whose frequency and phase are synchronized with a data signal.

10. The method of claim 1, wherein the signal is optical.

11. The method of claim 1, further comprising modulating the combined signal.

12. A method for receiving a signal, comprising:
generating a polarized signal based on receiver-side feedback;
combining an ingress traffic signal with the polarized signal to generate a combined signal;
splitting the combined signal into a first split signal and second split signal;
detecting the first split signal; and
detecting the second split signal.

13. The method of claim 12, wherein the ingress traffic signal is compensated for polarization mode dispersion.

14. The method of claim 12, wherein the polarization is circular.

15. The method of claim 12, wherein the first split signal comprises a first component of the received signal.

16. The method of claim 12, wherein the second split signal comprises a second component of the received signal.

17. The method of claim 12, wherein the ingress traffic signal is optical.

18. The method of claim 12, wherein the combined signal is split by a polarization beam splitter (PBS).

19. The method of claim 18, wherein the polarization of a first component of the ingress traffic signal is aligned to an axis of the polarization beam splitter.

20. A system for transmitting a signal, comprising:
a means for providing a source signal;
a means for splitting the source signal into a first split signal and second split signal;
a means for modulating the first split signal based on a first dataset to generate a modulated first split signal;
a means for shifting a phase of the second split signal to generate a phase-shifted second split signal;
a means for modulating the phase-shifted second split signal based on a second dataset to generate a modulated second signal;
a means for controlling the polarization of the modulated second signal to generate a polarized signal; and
a means for combining the modulated first split signal and the polarized signal to generate a combined signal.

21. The system of claim 20, wherein the polarization of the modulated second signal is orthogonal to the polarization of the modulated first signal.

22. The system of claim 20, wherein the phase shift is ninety degrees;

23. The system of claim 20, wherein immediately prior to combination, the polarization of the modulated first signal is transverse electric (TE) polarization, and the polarization of the polarized second signal is transverse magnetic (TM) polarization.

24. The system of claim 20, wherein the modulation is by phase modulation.

25. The system of claim 20, further comprising a means for modulating the source signal.

26. The system of claim 25, wherein the source signal is modulated by intensity modulation.

27. The system of claim 26, wherein the intensity modulation is periodic.

28. The system of claim 26, wherein the intensity modulation is by a clock signal whose frequency and phase are synchronized with a data signal.

29. The system of claim 28, wherein the clock signal is at a symbol rate.

30. The system of claim 20, wherein the signal is optical.

31. The system of claim 20, wherein the source signal means is a continuous wave laser.

32. The system of claim 20, wherein the source signal is split by a polarization beam splitter; and
wherein the source signal is circularly polarized.

33. The system of claim 20, wherein the source signal is split by a half mirror.

34. The system of claim 20, wherein the source signal is split by a three decibel splitter.

35. The system of claim 20, wherein the phase shift means is by applying direct current (DC) voltage to the modulator.

36. The system of claim 20, wherein the means for controlling polarization is a half-wave plate.

37. A system for receiving a signal comprising:
a means for receiving a signal;
a means for providing a local signal;
a means for controlling a polarization of the local signal to generate an appropriately polarized local signal;
a means for combining the polarized local signal and received signal;
a means for splitting the combined signal into a first split signal and a second split signal;
a means for detecting the first split signal;
a means for detecting the second split signal; and
a means for generating feedback to modify the local signal.

38. The system of claim 37, wherein the received signal is compensated for polarization mode dispersion.

39. The system of claim 37, wherein the signal is received by an automatic polarization controller.

40. The system of claim 37, wherein the appropriate polarization of the local signal is circular.

41. The system of claim 37, wherein the first split signal comprises a first component of the received signal.

42. The system of claim 37, wherein the second split signal comprises an orthogonally polarized second component of the received signal.

43. The system of claim 37, wherein the signal is optical.

44. The system of claim 37, wherein the local signal is provided by a continuous wave laser.

45. The system of claim 37, wherein the local signal means yields circularly polarized light.

46. The system of claim 37, wherein the means to control polarization is a quarter wave plate.

47. The system of claim 37, wherein the combiner means is a 3 decibel splitter.

48. The system of claim 37, wherein the combiner means is a half mirror.

49. The method of claim 37, wherein the splitting means is a polarization beam splitter; and
a first component of the signal is aligned to an axis of the polarization beam splitter.

50. The system of claim 37, wherein the detecting means is a photodiode.

51. An optical transmitter, comprising:
a carrier signal generator, operable to generate an optical signal;
an intensity modulator, optically coupled to the carrier signal generator and operable to modulate an intensity of the optical signal to generate an intensity modulated signal;
a first beam splitter, optically coupled to the intensity modulator and operable to receive and divide the intensity modulated signal into two separate signals;
a first phase modulator, optically coupled to the first beam splitter and operable to receive a data stream and modulate a phase of an optical signal based on the data stream to generate a first modulated signal;
a phase shifter, optically coupled to the first beam splitter and operable to shift a phase of an optical signal;
a second phase modulator, optically coupled to the phase shifter and operable to receive a data stream and modulate a phase of an optical signal based on the data stream to generate a second modulated signal;
a half wave plate, optically coupled to the second phase modulator and operable to receive the second modulated signal and generate a signal with a polarization state that is orthogonal to the polarization state of the first modulated signal to generate an orthogonal signal;
a second polarization beam splitter, optically coupled to the first phase modulator and the half wave plate and operable to combine the first modulated signal with the orthogonal signal to generate a combined signal.

52. An optical receiver, comprising:
a local oscillator optically coupled to a quarter wave plate and operable to generate an optical signal;
the quarter wave plate optically coupled to a first beam splitter and operable to receive an optical signal, circularly polarize the optical signal to generate a circularly polarized signal, and transmit the polarized signal to the first beam splitter;
the first beam splitter optically coupled to a second polarization beam splitter and operable to receive an optical traffic signal, combine the optical traffic signal with the circularly polarized signal to generate a combined signal, and transmit the combined signal to the second polarization beam splitter;
the second polarization beam splitter optically coupled to a first photodiode and a second photodiode and operable to receive the combined signal, split the combined signal into a first split signal and a second split signal, and transmit the first split signal to the first photodiode and the second split signal to the second photodiode;
the first photodiode coupled to a decision circuit and operable to receive the first split signal, generate a first data signal based on the first split signal, and transmit the first data signal to the decision circuit;
the second photodiode coupled to a decision circuit and operable to receive the second split signal, generate a second data signal based on the second split signal, and transmit the second data signal to the decision circuit;
the decision circuit coupled to a feedback control module and operable to determine a desired optical signal generated by the local oscillator generate a control signal based on the desired optical signal, and transmit the control signal to the feedback control module;
the feedback control module coupled to the local oscillator and operable to generate an oscillator control signal based on the control signal; and
the local oscillator operable to receive the oscillator control signal and modify the optical signal based on the oscillator control signal.

53. A method for generating a signal for transmission, comprising:
combining a first signal having a first polarization state with a second signal having a second polarization state orthogonal to the first polarization state to generate a QPSK signal; and
intensity modulating a signal associated with the QPSK signal, the signal comprising one of a carrier signal and the QPSK signal.

54. A method for processing a signal, comprising:
receiving an intensity modulated QPSK signal comprising orthogonal components; and
decoding the QPSK signal.
